(19) United States
(12) Patent Application Publication
(10) Pub. No.: US 2021/0015146 A1
(43) Pub. Date: Jan. 21, 2021

(54) APPARATUS FOR PREPARING A PERSONAL SMOKABLE PRODUCT

(71) Applicant: Cannayama Industries Inc., Vancouver (CA)

(72) Inventors: Brock C. Chaben, Vancouver, BC (CA); Jeffrey Jackson, Vancouver, BC (CA)

(73) Assignee: Cannayama Industries Inc., Vanocuver, BC (CA)

(21) Appl. No.: 17/043,231

(22) PCT Filed: Apr. 2, 2019
(86) PCT No.: PCT/CA2019/050396

§ 371 Date: Sep. 29, 2020

Related U.S. Application Data
(60) Provisional application No. 62/652,257, filed on Apr. 3, 2018.

(51) Int. Cl. A24C 5/42; A24B 7/10; A24B 7/14; A24F 40/20; A24F 40/10; A24F 40/42; A24F 40/48; A24F 40/30; B02C 18/10; H04R 1/02

(52) U.S. Cl. CPC A24C 5/42; A24B 7/10; A24B 7/14; A24F 40/20; A24F 40/10; B02C 2018/188; A24F 40/48; A24F 40/30; B02C 18/10; H04R 1/028; A24F 40/42

(57) ABSTRACT

An apparatus for preparing a personal smokable product includes: a grinder section comprising a grinder for grinding plant material; a holder section attachable to the grinder section and comprising a holder receiving a wrapper support for supporting a wrapper for receiving ground plant material when aligned with the grinder; and one or more removably attachable auxiliary modules, which may include a dry herb vaporizer, an oil vaporizer, an audio speaker, and/or a storage compartment. The grinder includes a cutter having wall blades projecting from a chamber-defining wall toward a central axis of the chamber; a motor-driven shaft rotatable about the central axis, and shaft blades projecting radially from the shaft. The grinder includes conical bun members with an adjustable gap for coarseness. Even when the grinder section and the holder section are attached to each other, the wrapper is user-accessible if the holder is in its non-aligned position.

### CROSS-REFERENCE TO RELATED APPLICATIONS

This application claims priority of provisional application 62/652,257, filed Apr. 3, 2018.

### BACKGROUND OF THE INVENTION

### 1. Field of Invention

This invention relates to personal smokable products and, more particular, to an apparatus for preparing, dispensing, and storing personal smokable products and personal inhalable products.

### 2. Description of Related Art

Personal smokable products for adult use include cigarettes containing ground plant material such as tobacco or other herbs, medicinal marijuana, legalized cannabis, or other plant material. Personal inhalable products include vapors produced by vaporizers, including dry herb vaporizers and oil vaporizers. However, cigarettes are often sold pre-made, and cigarette makers and vaporizers are conventionally sold separately.

U.S. Pat. No. 9,814,259 to Richmond et al. discloses a system for preparing personal smokable products comprising a wall providing an upper chamber and a lower chamber with a grate between the chambers. Feed smokeable material in the upper chamber has its size reduced with a size reducer a sufficient amount that it can pass through the grade into the lower chamber as fill smokeable material. A support below the lower chamber is provided for supporting a wrapper. There is an opening in the lower chamber for fill smokeable material to pass into the wrapper. An axially moveable tamper can tamp the fill smokeable material in the wrapper. Biasing means bias the wall and tamper into the upper position. A mechanism is provided for moving the tamper from its upper position to its lower position against the biasing means for tamping the smokeable material in the wrapper.

However, the system of Richmond et al. provides tamping in one axial direction only, which limits the angles at which the tamper can be applied to tamp the fill smokeable material in the wrapper.

United States patent application publication No. 2017/0258132 to Rostami et al. discloses a combined cartridge for electronic vaping. The catridge includes a dispensing interface coupled to a plurality of reservoirs and a heater coupled to the dispensing interface in a housing. The dispensing interface may include a trunk and separate roots extending into separate reservoirs, such that the dispensing interface draws different pre-vapor formulations from the reservoirs to the trunk via the separate roots. The heater is coupled to the trunk, such that the heater is operable to simultaneously vaporize the different pre-vapor formulations drawn into the trunk. The heater may be configured to heat the separate portions of the trunk at different rates simultaneously.

However, the cartridge of Rostami et al. is not operable to separately activate heating at different reservoirs and thus not operable to selectively vaporize a selected subset of pre-vapor formulations present in the trunk.

An object of the invention is to address the above shortcomings.

### SUMMARY

The above shortcomings may be addressed by providing, in accordance with one aspect of the invention, an apparatus for preparing a personal smokable product. The apparatus includes: (a) a grinder section comprising a grinder for grinding plant material; and (b) a holder section attachable to the grinder section and comprising a holder operable to move between an aligned position in alignment with the grinder and a non-aligned position out of alignment with the grinder, the holder being operable to removably receive a wrapper support when the grinder section and the holder section are attached to each other if the holder is in the non-aligned position, the wrapper support being dimensioned to support a wrapper, the grinder being operable to grind the plant material such that ground plant material moves into the wrapper supported by the wrapper support received by the holder when the holder is in the aligned position.

The grinder section and the holder section may be removably attachable to each other. The holder may be operable to removably receive any one of a plurality of the wrapper supports differently dimensioned from each other, each of the differently dimensioned wrapper supports being operable to support a correspondingly dimensioned one of a plurality of the wrappers. The holder may be rotatably coupled to the holder section. The holder may be slidably coupled to the holder section. The holder may be slidably and rotatably coupled to the holder section. The holder may include a window for viewing the ground plant material received into the wrapper, the wrapper support not being opaque. The holder may include a light source for illuminating the ground plant material received by the wrapper supported by the wrapper support received by the holder. the holder section may include a magnet for holding the holder in the aligned position. The holder may be dimensioned to removably hold a tamping tool. The tamping tool may define a first end and a second end opposite the first end. The tamping tool may define at the first end a tamping surface. The tamping tool may include tweezers at the second end. The wrapper support may be frusto-conical and open-topped.

In accordance with another aspect of the invention, there is provided an apparatus for preparing a personal smokable product. The apparatus includes: (a) a grinder section comprising a grinder for grinding plant material to produce ground plant material, the grinder defining a wall and a chamber interior of the wall, the chamber defining a central axis therethrough, the grinder comprising a cutter member for cutting plant material, the cutter member comprising: (i) a plurality of spaced-apart wall blades projecting from the wall toward a first plurality of positions along the central axis; (ii) a motor-driven shaft rotatable about the central axis, and (iii) a plurality of spaced-apart shaft blades projecting radially from the shaft at a second plurality of positions along the central axis; and (b) a holder section attachable to the grinder section and comprising a holder operable to removably receive a wrapper support dimensioned to support a wrapper operable to receive the ground plant material from the grinder.

The chamber may define an upper cutting end thereof. The plurality of shaft blades may include at the upper cutting end a plurality of parallel shaft blades parallel to each other. The chamber may define a lower cutting end thereof. The plurality of shaft blades may include at the lower cutting end a plurality of non-parallel shaft blades extending radially from the shaft at a plurality of different radial angles. The grinder may further include a grinder member disposed within the chamber. The grinder member may be disposed to receive cut plant material from the cutter member. The grinder member may be operable to grind the cut plant material to produce the ground plant material. The grinder member may include a pair of conical burr members. The grinder member may be operable to adjust the coarseness of the ground plant material in response to a coarseness setting. The grinder member may be operable to adjust a gap size between the conical burr members of the pair in response to the coarseness setting. The grinder section may include a user-operable dial for determining the coarseness setting. The grinder section and the holder section may be removably attachable to each other. The cutter member and the grinder member may be driven by the motor-driven shaft. The motor-driven shaft may be operable to sequentially rotate in opposing rotational directions. The chamber may define a cutting chamber. The chamber may define a grinding chamber. The cutting chamber may be frusto-conical. The cutting chamber may define a narrow cutting chamber end. The grinding chamber may be frusto-conical. The grinding chamber may define a narrow grinding chamber end. The narrow grinding chamber end may be coincident with the narrow cutting chamber end.

In accordance with another aspect of the invention, there is provided an apparatus for preparing a personal smokable product. The apparatus includes: (a) a grinder section comprising a grinder for grinding plant material to produce ground plant material; (b) a holder section attachable to the grinder section and comprising a holder operable to removably receive a wrapper support dimensioned to support a wrapper for receiving the ground plant material; and (c) one or more auxiliary modules removably attachable to at least one of the grinder section and the holder section.

The one or more auxiliary modules may be selected from the group consisting of: a dry herb vaporizer, an oil vaporizer, at least one audio speaker, and at least one storage compartment. The one or more auxiliary modules may include the dry herb vaporizer. The one or more auxiliary modules may include the oil vaporizer. The apparatus may further include a motor section. The motor section may be attachable to the grinder section. The motor section may include a motor operable to drive the grinder. The motor may be operable to drive a shaft of the grinder section. The motor section may be operable to receive a battery for supplying electrical power to the motor. The apparatus may further include a docking station. The docking station may be operable to charge the battery. The docking station may be dimensioned to removably receive the holder section. The motor section may be removably attachable to the grinder section. The motor section may be dimensioned to removably contain a hand-portable lighter. The apparatus may further include at least one audio speaker. The one or more auxiliary modules may include the at least one audio speaker. The speaker may be removably attachable to at least one of the grinder section and the holder section. The apparatus may further include at least one storage compartment removably attachable to at least one of the grinder section and the holder section. The one or more auxiliary modules may include the at least one storage compartment. The holder section may be dimensioned to provide storage space of sufficient size to contain the wrapper support. The apparatus may be dimensioned to removably hold a tamping tool. The holder section may be dimensioned to removably hold the tamping tool. The tamping tool may define a first end and a second end opposite the first end. The tamping tool may define at the first end a tamping surface. The tamping tool may include tweezers at the second end. The oil vaporizer may include a base member. A mouthpiece member may be attachable to the base member. The mouthpiece member may be rotatable when attached to the base member between a useable position projecting from the base member and a storage position permitting the oil vaporizer to removably attach to the at least one of the grinder section and the holder section. The base member may include: (i) a plurality of adapters for removably receiving a plurality of vapor cartridges operable to produce a plurality of vapors, respectively; (ii) a plurality of user-operated actuators for actuating the plurality of vapor cartridges, respectively; and (iii) a manifold for combining the plurality of vapors. The base member may further include a choke for regulating intake air flow to the manifold. The base member may be dimensioned to removably receive a battery for powering the plurality of vapor cartridges.

In accordance with another aspect of the invention, there is provided an electronic herb grinder and cigarette maker system. The system is a three-part system for plant material grinding, storage, and filling of pre-rolled papers. Plant material desired to be ground is placed into the top portion which contains a grinding means. Below this is a storage area which is above, and can funnel to, a pre-rolled paper holder.

In accordance with another aspect of the invention, there is provided a three-tiered system which has a lid at the top and underneath the lid contains one of two types of grinding mechanisms. The lid contains the motor/gear reduction system, rechargeable battery assembly and recessed lockable switch used to power and activate the device and a LED light ring to signify the device is on. The lid connects to the grinder and auger assembly via a ¼ turn bayonet mount. There is a copper bridge on the lid and grinder/auger assembly that completes the circuit only when the two components are connected. This connection creates a safety feature whereby the device can only be activated when the lid is connected to the Grinder/Auger/Funnel System.

The grinding mechanism may be a herb grinder in which teeth on the top and bottom rotate past each other and tear the plant material apart. Spacing may be included between the teeth of the grinder to load in larger masses of tobacco and herb easily. This may control the amount of herb entering the grinder as well as minimize the need for subsequent loads to fill the pre-rolled tube. A post may rotate around the circumference of the grinder blades to clear the edges forcing the material to the center of the filter bed. Intersecting the herb grinder to the lid/motor may be an auger bit that is attached via lockable teeth and magnets. The tapered screw auger attached to the bottom of the lid via magnetic socket and teeth may sit freely through a bearing directly below the filter bed. The screw auger may be housed within a funnel tube so as it rotates it transports the ground material to the bottom of the funnel. The bottom of the funnel may connect vertically to the storage via a ¼ turn bayonet mount. The bottom of the funnel tube may have a sealing/capping mechanism (Shutter House Switch) to prevent ground herb from leaking when the storage assembly is detached.

The grinding mechanism may be a tapered screw auger with horizontal spacing in each blade, the interior of the walls having blades spaced to interact with the blades of the auger. The auger may taper at the bottom and form a funnel for the plant material to collect into.

Below the grinding mechanism may be a storage area, at the center of which forms a cylindrical location where a pre-made cigarette tube is able to be placed that ‘sleeves’ over the end of the auger funnel tube. Around the space for the cigarette tube may be a storage for ground plant material as well as for brushes, other cleaning supplies and a removable pipe. Directly below the Storage assembly may be a dock charger directly connected via copper bridges to the circuitry in the lid. The Dock Charger may connect to a transformer that can plug into any wall outlet to charge the device. The device may be rechargeable via a Li-Ion battery and Micro USB-USB cable. Charging may be accomplished via a rechargeable battery that is charged via micro-usb and/or charging dock. A motor, battery pack and switch and circuitry may be disposed within the lid portion of the device. Copper leads may connect from the dock charger to the base of the storage component. The device may be portable.

In accordance with another aspect of the invention, there is provided a three-tiered device which can grind, store and create cigarettes from plant material placed within it. The plant material is placed into the top portion which is the grinder, the material is ground and then moves into a funnel and storage area. The plant material can either be funneled into a pre-rolled cigarette tube that is fitted over the funnel, funneled into the pipe attachment or it can simply be deposited in the storage area above the funnel for use at a later time (e.g. deposited into the storage area attached adjacent to the tube cylinder).

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a perspective view of an apparatus for preparing personal smokable products according to a first embodiment of the invention;

FIG. 2 is a cut-away elevation view of an interior portion of the apparatus shown in FIG. 1, showing a motor of a motor section of the apparatus, a cutter member and a grinder member of a grinder section of the apparatus, a wrapper support of a holder section of the apparatus, and a docking station;

FIG. 3 is a perspective view of the holder section of the apparatus shown in FIG. 1, showing a holder in a non-aligned position;

FIG. 4 is a perspective view of the apparatus shown in FIG. 1, showing storage compartments of the apparatus in their open position at the grinder section and showing auxiliary modules of the apparatus separated from the holder section;

FIG. 5 is a perspective view of a portion of the apparatus shown in FIG. 1, showing the motor section hingedly attached to the grinder section; and

FIG. 6 is a block diagrammatic view of one auxiliary module of the apparatus shown in FIG. 1, the auxiliary module being in the form of an oil vaporizer, showing the contents of the oil vaporizer.

### DETAILED DESCRIPTION

An apparatus for preparing a personal smokable product includes: (a) cutting means for cutting plant material to produce cut plant material; (b) grinder means for grinding the cut plant material received from the cutting means to produce ground plant material; and (c) holding means for holding a wrapper for receiving the ground plant material. The apparatus may further include vaporizer means for producing an inhalable vapor.

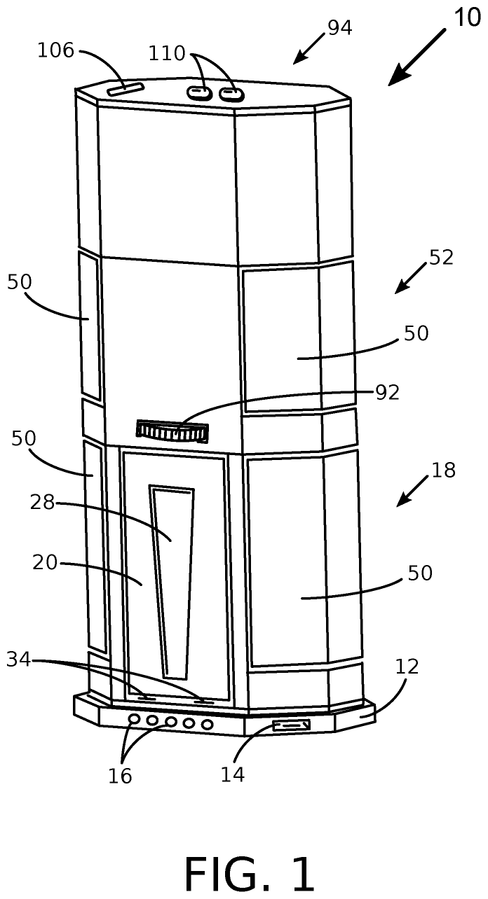

Referring to FIG. 1, the apparatus according to a first embodiment of the invention is shown generally at 10. The apparatus 10 is a multi-purpose device for adult use that is operable to prepare, dispense, and store personal smokable products such as cigarettes and operable to produce inhalable vapor.

The apparatus 10 of the first embodiment includes a docking station 12 for recharging a battery or batteries of the apparatus 10. The docking station 12 includes a Universal Serial Bus (USB) connector 14 for receiving direct-current (DC) electrical power to power electrical circuits of the apparatus 10. Additionally or alternatively, the apparatus 10 in some embodiments includes a connector and/or cable (not shown) for receiving alternating-current (AC) electrical power for powering electrical circuits of the apparatus 10. Additionally or alternatively, the apparatus 10 in some embodiments is operable to recharge the battery or batteries of the apparatus 10 by wireless charging via the docking station 12. For example, the apparatus 10 including the docking station 12 may be placed on or otherwise proximate to a wireless charging pad (not shown).

The docking station 12 includes a number of light sources such as the Light-Emitting Diodes (LEDs) 16 for providing status indications associated with the operation of the apparatus 10.

The docking station 12 in some embodiments include a processor or other processing circuit (not shown) such as a micro-controller or other digital computation device and may include a memory circuit (not shown) for storing data including program data for directing operations of the processor or other processing circuit.

In the first embodiment, the docking station 12 is operable to perform digital and/or analog communications, such as for communication and control of other features of the apparatus 10 described herein below and/or communication with other communications-enabled devices (not shown) such as smart phones, tablet computers, laptop computers, or other smart devices. Communications between the docking station 12 and other features of the apparatus 10, and/or communications between the apparatus 10 and other communications-enabled devices may be conducted by wired and/or wireless communications via direct point-to-point communications link and/or indirect communications link, such as via a telecommunications network, LAN (local-area network), WAN (wide-area network), and/or a global communications network such as the Internet for example. Communication via an indirect link may be implemented using any suitable telephone or other communications technology, for example. In the first embodiment, the docking station 12 is operable to communicate by near-field wireless communications, such as by Bluetooth™ standard communications. Additionally or alternatively, the docking station 12 in some embodiments is operable to communicate by NFC (Near-Field Communications) standard communications, or the like. Additionally or alternatively, the docking station 12 in some embodiments is operable to communicate via the Internet, such as in the manner of a backup method in case of failure to communicate via near-field wireless communications for example. In general, communications may be transmitted via any wired or wireless connection, including a copper wire link, a coaxial cable link, a fiber-optic transmission link, a radio link, a cellular telephone link, a satellite link, a line-of-sight free-optics link, and any combination thereof for example.

In some embodiments, the apparatus 10 is operable to receive voice commands. For example, the apparatus 10 may be operable to conduct searching of Internet-accessible electronic databases in response to voice commands. In some embodiments, the apparatus 10 is operable to produce sound. For example, the apparatus 10 may be operable to provide search results of the Internet search in the form of answers to questions by producing sound. In the first embodiment, the processor is operable to make a sound, such as a musical chime, when first activated or at other suitable times. In some embodiments, the apparatus 10 is operable to tell theme-related jokes and to produce audible voice-synthesized commentary.

The docking station 12 in the first embodiment is dimensioned to removably receive the holder section 18, which is correspondingly dimensioned to rest atop the docking station 12. In the first embodiment, the docking station 12 includes a non-slip bottom such as by employing a rubber material at the docking station 12 bottom.

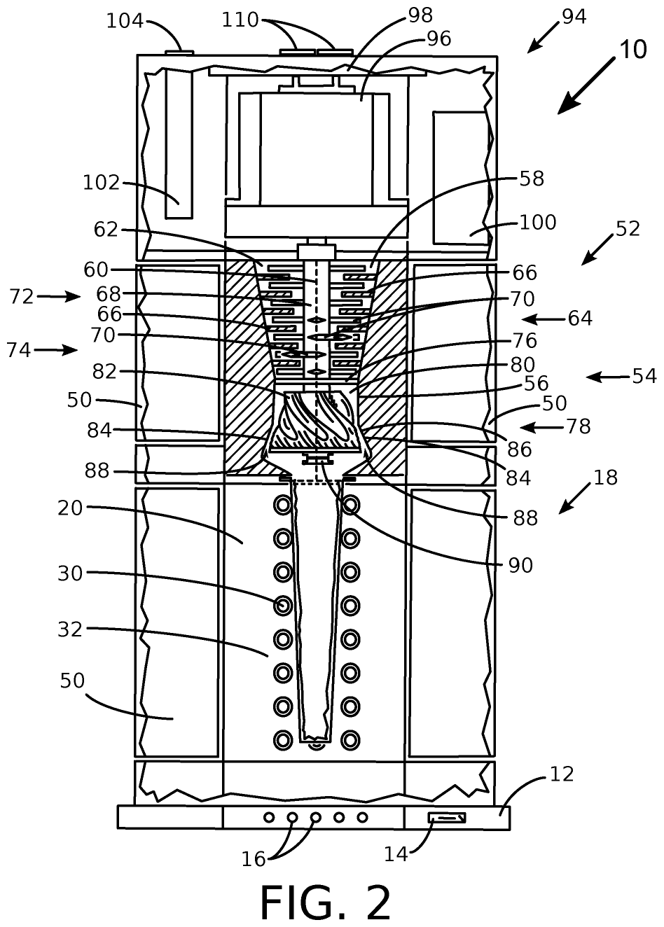

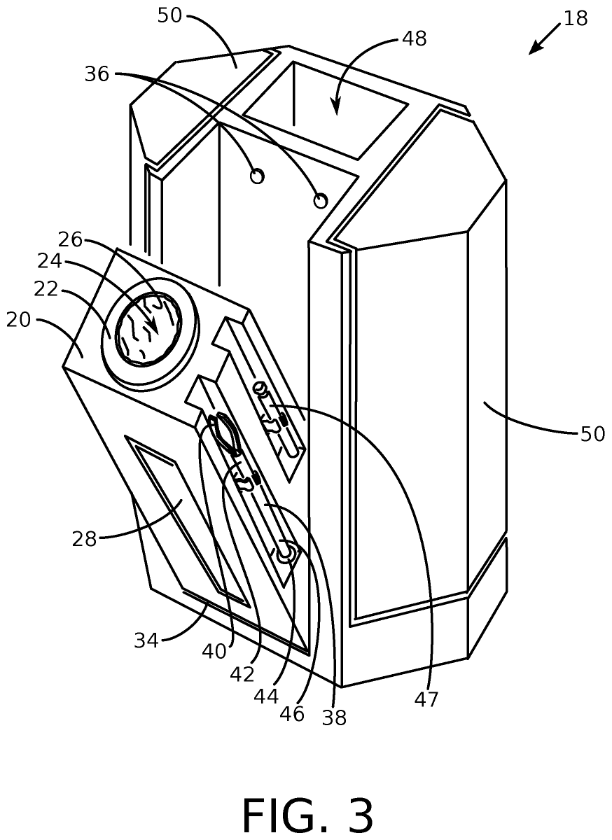

Referring to FIGS. 1 to 3, the holder section 18 includes a holder 20 that is moveable between an aligned position, as shown in FIGS. 1 and 2, and a non-aligned position, as shown in FIG. 3. The holder 20 is operable to hold a wrapper support 22 that is removable and replaceable. The wrapper support 22 has an open top 24 and is frusto-conical to removably receive a wrapper 26.

Typically, the wrapper 26 is cone-shaped, open-topped, and made of paper or similar material(s) to receive tobacco or other herbs, medicinal marijuana, legalized cannabis, or other plant material for adult use as a smokable cigarette. In variations, a plurality of different shapes, lengths, and width profiles can be used. A variety of wrapper supports 22 of different dimensions are able to fit into the holder 20, with each differently dimensioned wrapper support 22 corresponding to a differently shaped wrapper 26. In some embodiments, the apparatus 10 includes a set of differently dimensioned wrappers 26 and correspondingly dimensioned wrapper supports 22. In other embodiments, the apparatus 10 includes a set of differently dimensioned wrapper supports 22 only such that the wrappers 26 are sold separately from the apparatus 10. In some embodiments, the wrapper supports 22 are also sold separately from the apparatus 10.

In the first embodiment, each wrapper support 26 is removably attachable to the holder 20 such as by a bayonet-style mount. Additionally or alternatively, each wrapper support 26 may threadedly engage the holder 20. In some embodiments, the holder 20 includes a clip, lock or other fastener (not shown) for receiving and locking the wrapper support 26 in place. In general, any suitable mechanism for removably attaching the wrapper support 26 to the holder 20 may be employed.

Referring back to FIG. 1, the holder 20 of the first embodiment includes a window 28 to permit viewing of any of the wrapper support 22, its wrapper 22, and its contents that are present inside the holder 20. For this reason, the wrapper support 22 is not opaque, and is preferably transparent or nearly transparent, in the first embodiment. Typically, the wrapper 26 is made of a thin sheet of paper or similar material such that it is possible to see through the window 28 to ascertain the level and density of any contents in the wrapper 26.

Referring to FIG. 2, the holder 20 of the first embodiment includes a plurality of light sources, such as the Light-Emitting Diodes (LEDs) 30, which provide back-lighting to assist viewing the contents, if any, of the wrapper 26 inside the holder 20. The LEDs 30 are disposed on the interior of a back wall 32 of the holder so that the wrapper support 22 and wrapper 26 inside the holder 20 lie between the LEDs 30 and the window 28.

Referring to FIGS. 1 to 3, the holder 20 is coupled to a main part of the holder section 18, which in the first embodiment is hingedly attached to the main part of the holder section 18 by one or more hinges 34 to permit the holder 20 to move between its aligned position (FIGS. 1 and 2) and non-aligned position (FIG. 3). Additionally or alternatively, the holder 20 in some embodiments is slidably coupled to the main part of the holder section 18, such as by being operable to slide forward from its aligned position to its non-aligned position and by being operable to slide rearward from its non-aligned position to its aligned position. In some embodiments, the holder 20 is operable to move between its aligned and non-aligned positions by a combination of sliding and rotating.

The holder section 18 shown in FIG. 3 includes a pair of magnets 36 (FIG. 3) for maintaining the holder 20 in its aligned position (FIG. 1). In variations, either or both of the holder section 18 and the holder 20 may include any number of magnets 36. Additionally or alternatively, the holder 20 may be kept in either or both of its aligned and non-aligned positions by fastener(s), clip(s), lock(s), elastic member(s), other mechanism(s), or any combination thereof for example.

In the first embodiment, the apparatus 10 is operable to store various accessories. For example, the holder 20 is operable to removably hold the tamping tool 38 shown in FIG. 3. In the first embodiment, the tamping tool 38 provides a pair of tweezers 40 at its upper end 42 and a tamping surface 44 at its lower end 46. The tweezers 40 are advantageously useable to insert and remove the wrapper 26 into and from the wrapper support 22, while the tamping surface 40 advantageously facilitates tamping plant material within the wrapper 26 and supported by the wrapper support 22. Having the tweezers 40 and tamping surface 44 formed within the same tool 38 advantageously provides a compact, multi-purpose accessory.

In some embodiments, the holder 20 is operable to removably hold a one-hitter style smoking pipe 47. The pipe 47 is typically made of glass, metal or similar, and is typically dimensioned to hold a small amount of plant material (not shown), to define a mouthpiece for inhaling smoke created by burning the plant material, and to define a pipe between its plant-material holding end and its mouthpiece end.

The holder section 18 in the first embodiment is dimensioned to define a holder storage space 48, which is dimensioned to store miscellaneous items (not shown) such as spare wrapper support(s) 22 and/or wrapper(s) 26, which may be empty or non-empty wrapper(s) 26, of varying, corresponding or matching dimensions.

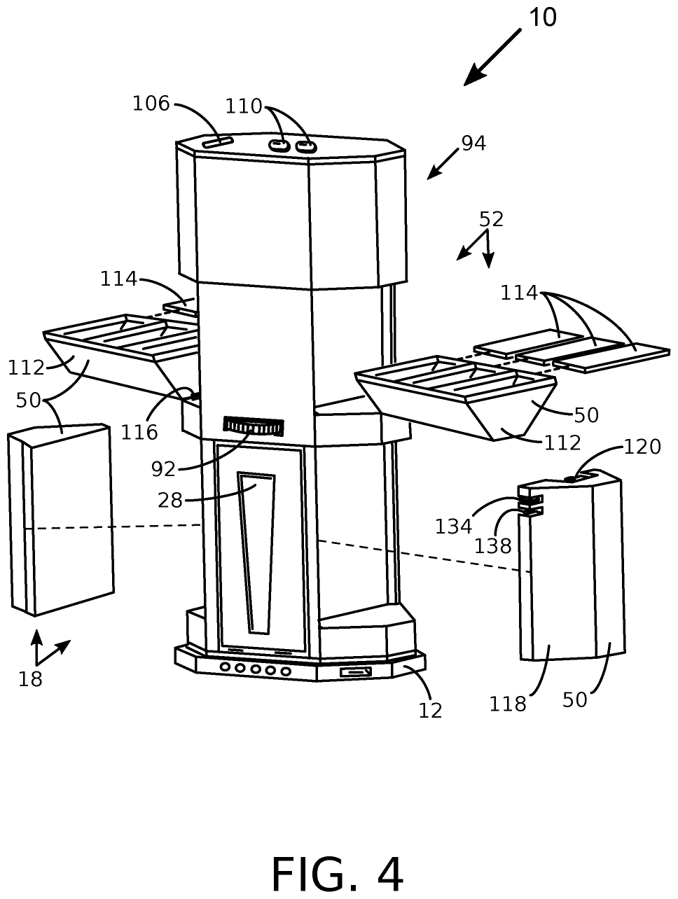

Referring particularly to FIG. 4, the apparatus 10 in the first embodiment includes a pair of auxiliary modules 50 removably attachable to the holder section 18 at opposing sides of the holder 20. The function(s) and purpose(s) of the auxiliary modules 50 can vary between different embodiments of the apparatus 10, and advantageously provide additional features of the present invention further described herein below.

Referring back to FIGS. 1 and 2, the apparatus 10 includes a grinder section 52 to which a corresponding pair of auxiliary modules 50 is removably attachable.

The grinder section 52 and the holder section 18 are attachable to each other and, in the first embodiment, are removably attachable to each other. In some embodiments, the grinder section 52 and the holder section 18 are permanently attached to each other, including in some embodiments being integrally attached to each other.

Referring to FIG. 2, the grinder section 52 includes a grinder 54 for grinding plant material (not shown) to produce ground plant material (not shown) for release into the holder section 18.

The grinder section 52 in the first embodiment includes one wall 56 circumscribing the chamber 58, which defines several frusto-conical portions thereof about a central axis 60. In the first embodiment, the chamber 58 has a circular cross-section when viewed from above (not shown). In the first embodiment, the chamber 58 defines a cutting chamber 62 that houses the cutting member 64 for cutting the plant material. The cutting member 64 includes a plurality of wall blades 66 that project from the wall 56 toward the central axis 60, thereby forming cantilevers. The wall blades 66 are spaced apart along the wall 56 projecting toward different positions along the central axis 60. In the first embodiment, first and second sets of the wall blades 66 project from opposing sides of the wall 56, respectively, with the wall blades 66 of each set being parallel to each other along a vertical plane. The length of the wall blades 66 vary according to their position along the associated frusto-conical portion of the wall 56. In the first embodiment, all of the wall blades 66 project to the same distance from a shaft 68 that is rotatable about the central axis 60. In general, however, the wall blades 66 may have any suitable length, any suitable spatial relationship to each other, and form any number of sets thereof.

A plurality of shaft blades 70 project from a plurality of positions along the shaft 68 in the manner of a cantilever toward the wall 56. The shaft blades 70 are spaced apart and each shaft blade 70 extends so as to pass adjacent to at least one wall blade 66 when radially aligned with such wall blade 66. Thus, the wall blades 66 and the shaft blades 70 do not collide with each other as the shaft 68 rotates, but rather passes adjacently by and between each other to produce a cutting action. In some embodiments, the wall blades 66 and the shaft blades 70 are dimensioned, such as having angled blade-edge profiles (not shown), to produce a scissor-like cutting action. In general, any suitable blade-edge profile may be employed.

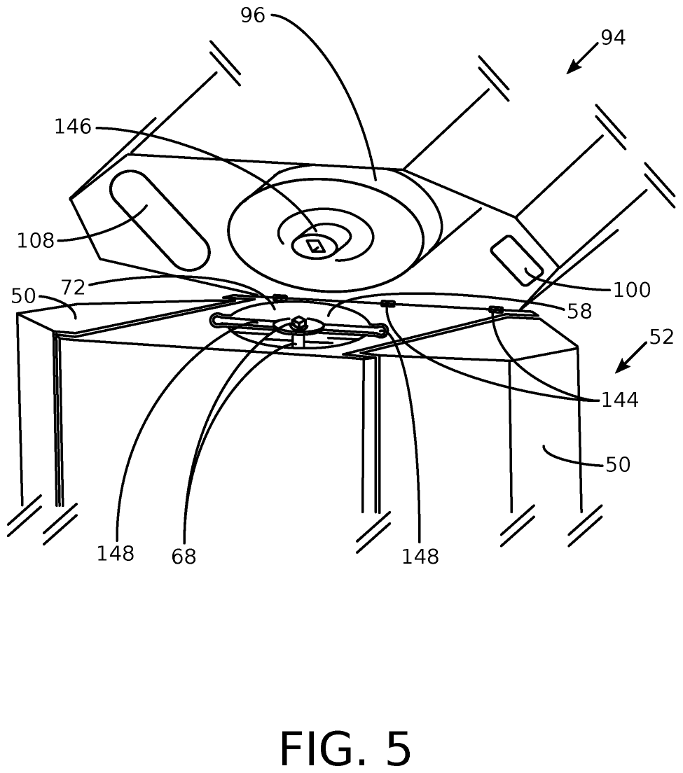

Referring to FIGS. 2 and 5, in the first embodiment the chamber 58 further defines an upper cutting end 72 of the chamber 58 in which the shaft blades 70 project from opposing sides of the shaft 68 at two opposing radial angles so that the shaft blades 70 in the upper cutting end 72 of the chamber 58 lie within one vertical plane. The shaft blades 70 at the upper cutting end 72 projecting from the shaft 68 at each radial angle are parallel to each other. The shaft blades 70 at a lower cutting end 74 of the chamber 58 project from the shaft 68 a variety of radial angles such that the shaft blades 70 at the lower cutting end 74 include non-parallel shaft blades 70. As best seen in FIG. 5, the upper cutting end 72 of the chamber 58 advantageously provides at all rotational positions of the shaft 68 at least one volume cleared of wall blades 66 and shaft blades 70, thereby advantageously providing a receiving space for a user to insert plant material prior to being cut and ground by the apparatus 10. Referring back to FIG. 2, the non-parallel shaft blades 70 at the lower cutting end 74 of the chamber 58 advantageously prevent larger inserted and uncut plant material from merely falling through to the bottom of the cutter member 64. In some embodiments, the cutter member 64 includes non-parallel wall blades 66 extending from a variety of radial wall 56 positions circumscribing the shaft 68.

The cutter member 64 in the first embodiment includes a mechanical filter, such as the grate 76 shown in FIG. 2, disposed at the bottom of the cutter member 64. The grate 76 has apertures (not visible in the Figures) of a suitable size to permit fully cut plant material to fall below the cutter member 64 while retaining larger uncut plant material in the cutter member 64 for further cutting.

Still referring to FIG. 2, a grinder member 78 is disposed within a grinding chamber 80 defined within the chamber 58 of the grinder section 54 as that portion of the chamber 58 below the cutting chamber 62. The grinder member 78 is operable to receive cut plant material that falls through the grate 76, and to grind the cut plant material to produce the ground plant material.

In the first embodiment of FIG. 2, the grinder member 78 includes an inner conical burr member 82 rotatable by the shaft 68 and an outer conical burr member 84 disposed at the portion 86 of the wall 56 circumscribing at least a portion of the inner conical burr member 82. In the first embodiment, the shaft 68 is operable to drive the inner conical burr member 82 by the shaft 68 engaging at its terminal end (not visible) the inner conical burr member 82 at a receiving socket (not shown) disposed at the top of the inner conical burr member 82. In variations, the inner conical burr member 82 may be removably or integrally attached to the shaft 68. The inner conical burr member 82 provides a rough surface as shown in FIG. 2.

The outer conical burr member 84 is typically formed within the wall 56 or mounted to the wall 56 at the portion 86 thereof as a corresponding rough surface. A gap 88 between the inner conical burr member 82 and the roughened portion 86 of the wall 56 permits ground plant material to pass by the grinder member 78 and fall into the holder section 18, while retaining larger pieces of cut plant material within the grinder member 78 for further grinding. In general, the larger the gap 88 the more coarse the ground plant material produced by the apparatus 10 is, and the smaller the gap 88 the finer, or less coarse, the ground plant material produced by the apparatus 10 is.

Referring to FIGS. 1, 2 and 4, the gap 88 in the first embodiment, is adjustable in response to a user-controlled coarseness setting of the apparatus 10. In the first embodiment, the apparatus 10 is operable to move the inner conical burr member 82 closer to and farther from the outer conical burr member 84, such as by moving the inner conical burr member 82 up and down vertically along the central axis 60. As shown in FIG. 2, the inner conical burr member 82 includes a base 90 and a mechanism (not shown in FIG. 2) for moving the base 90, and thus the inner conical burr member 82, along the central axis 60 in response to the user-controlled coarseness setting. Such mechanism is coupled in a manner generally known in the art to a user-operable dial 92 shown in FIGS. 1 and 4 for controlling the coarseness setting. In general, any suitable method for controlling the coarseness setting and any suitable mechanism for adjusting the gap 88 in response to the coarseness setting may be employed.

Referring to FIG. 2, the grinding chamber 80 defines a funnel-shaped portion thereof below the grinder member 78 such that when the apparatus 10 is upright and the holder 20 is in its aligned position the ground plant material available at the bottom of the grinding chamber 80 will fall by force of gravity into the wrapper 26 supported by the wrapper support 22 within the holding section 18. In some embodiments, an auger (not shown) attachable to at least one of the inner conical burr member 82 and the shaft 68 and disposed within the grinding chamber 80 below the inner conical burr member 82 assists the movement of the ground plant material toward the open top 24 of the wrapper support 22. In some embodiments, the inner surface of the funnel-shaped portion of the grinding chamber 78 is formed by and/or coated with a non-stick material such as a coated ceramic material. In general, any portion of the wall 56 other than the outer conical burr member 84 may be of the non-stick variety. The amount of ground plant material accumulating in the wrapper 26 can be viewed through the window 28 (FIGS. 1, 3 and 4).

In some embodiments, the funnel-shaped portion of the grinding chamber 78 extends into the holder section 18 and, in particular, below the open top 24 of the wrapper support 22 when the holder 20 is in its aligned position. In such embodiments, the holder 20 is operable to move past the grinder chamber 78, such as by dropping down and sliding and/or rotating forward, when moving from its aligned position to its non-aligned position.

While the first embodiment includes the grinder 54 with the cutter member 64 and the grinder member 78 as described and illustrated herein, variations of the grinder 54 may be suitably employed and, in general, any suitable mechanism for grinding plant material to become ground plant material for depositing into the holder section 20 may be employed. The wall blades 66, the shaft blades 70, and the grinding surfaces of the inner and outer conical burr members 82 and 84 may be made of any suitable material. For example, any of the wall blades 66, shaft blades 70, and the grinding surfaces of the inner and outer conical burr members 82 and 84 may be made of any of stainless steel, ceramic, aluminum, other hard material, or any combination thereof.

In some embodiments, the grinder 54 is operable to sense excessive resistance to rotation of the shaft blades 70 or the inner conical burr member 82, such as may be caused by a jam, and to reverse direction and/or cease operation.

Referring to FIG. 3, when a certain amount of the ground plant material has accumulated in the wrapper 26, a user may wish to tamp down the accumulated ground plant material, such as by stopping the grinding action, or allowing the grinding action to come to a stop, and then moving the holder 20 from its aligned position (FIGS. 1 and 2) to its non-aligned position shown in FIG. 3. In the first embodiment, the holder 20 is preferably operable to move between its aligned and non-aligned positions regardless of whether the holder section 18 and the grinder section 52 are attached to each other, such that the open top 24 of the wrapper support 22 becomes accessible when the holder 20 is in its non-aligned position (FIG. 3) even if the holder section 18 and the grinder section 52 are attached to each other. With the holder 20 in its non-aligned position, the tamping tool 38 may be employed by the user to tamp the accumulated ground plant material in the wrapper 26. Such tamping may occur at any user-desired position and angle at or within the wrapper 26. Upon tamping as desired, the holder 20 can be returned to its aligned position for further grinding and accumulating of ground plant material into the wrapper 26. This process may be repeated as desired by the user.

In some embodiments, the holder section 18 or its holder 20 is operable to simultaneously hold a plurality (not shown) of wrapper supports 22. In such embodiments, the apparatus may include a set of wrapper-support holders that, upon rotation, sequentially places an adjacent wrapper support in alignment with the grinder 54. In one implementation, the holder 20 (FIGS. 1 to 3) is modified for rotation and to hold multiple wrapper supports 22 with their respective open tops 24 disposed around a circular path (not shown), thereby forming the set of wrapper-support holders. In some embodiments, advancing the set from one aligned wrapper support 22 to the next involves manually rotating the set of wrapper supports 22. Additionally or alternatively, the set of wrapper supports 22 can be rotated by an electrical motor (not shown), for example. Such electrical motor in some embodiments is actuated by a user-activated button (not shown) or other user command. Additionally or alternatively, control of the electrical motor may be computerized such that the apparatus 10 is operable to sense when the wrapper 26 in a currently aligned wrapper support 22 becomes full of plant material and then automatically advance to the next adjacent wrapper support 22. Other variations are possible.

Referring to FIGS. 1, 2 and 4, the apparatus 10 includes a motor section 94 that includes a motor 96 for driving the shaft 68. In the first embodiment, the motor 96 is reversible for bi-directionally driving the shaft 68. The motor is in electrical contact with an electrical board 98 having thereon a controller (not shown). The controller is operable to control the motor 96 to perform uni-direction and/or bi-directional grinding of the plant material. In variations, the controller, or another controller (not shown), is operable to perform other control operations and/or digital computations of the apparatus 10. In the first embodiment, the apparatus 10 includes a battery 100 disposed within the motor section 94. The battery is operable in the first embodiment to supply power to the motor 96, which is typically a direct-current (DC) motor 96. Preferably, the battery 100 is a rechargeable battery. In the first embodiment, the apparatus 10 is operable to recharge the battery 100 via a wired electrical path between the motor section 94 and the docking station 12 when the motor section 94, grinder section 52, the holder section 18 and the docking station 12 are in electrical contact with each other. In general, however, any suitable recharging method may be employed and one or more non-rechargeable batteries may be employed in the apparatus 10.

In some embodiments, the apparatus 10 and/or the docking station 12 itself is operable to provide DC power to external devices, such as making available electrical charge stored in the battery 100, one or more batteries disposed in the docking station 12, and/or another battery or batteries of the apparatus 10.

The motor section 94 in the first embodiment is dimensioned to include a motor storage space 102 suitable for storing an accessory or accessories, such as a hand-portable lighter (not shown) which may be a flameless arc lighter, flame lighter, or the like. In variations, the motor storage space 102 can be accessible via a lid 104 on the outside of the apparatus 10 (FIG. 2), via a lidless opening 106 (FIGS. 1 and 4), and/or via an interior lid (not shown) and/or interior opening 108 disposed within the motor section 94 as shown in FIG. 5.

Referring to FIGS. 1, 2 and 4, the apparatus 10 includes at least one user-controllable actuating button 110 for actuating operation of the apparatus 10. The button 110 in the first embodiment is operable to cause the motor 96 to rotate the shaft 68 for grinding. In the first embodiment, a single press of the button 110 initiates a grinding routine involving a specified number of repetitions of rotating the shaft 68 in a first rotational direction for a fixed period of time and then rotating the shaft 68 in a second rotational direction opposite the first rotational directional for a second period of time, thereafter ceasing. In some embodiments, repetitions of first and then second rotations of the shaft 68 continue as long as the button 110 is held pressed. In the embodiment shown in the figures, one button 110 provides the programmed single-touch grinding described above while the other button 110 provides continuous grinding for as long as the other button 110 is held pressed. In variations, the continuous grinding may be in either one of the rotational directions or may be repetitions of alternating directions.

The button(s) 110 of the first embodiment are preferably dimensioned for ease of use by users of limited dexterity, such as users with arthritis or other medical conditions for which medicinal cannabis may be used. However, other combinations (not shown) of button(s) 110 and actuation features are possible. For example, in some embodiments a screen (not shown) is operable to display a selectable menu of user features, including possibly user-programmable operations. The screen may be a touch screen or presented in conjunction with a keyboard (not shown) of the apparatus 10. In some embodiments, the apparatus 10 is controllable and/or user-programmable via a smart device such as a mobile telephone, tablet computer, laptop computer, or the like for example.

In some embodiments, the apparatus 10 is operable to display the weight or mass of plant material (not shown), which may be plant material after being introduced into the grinder 54 and/or ground plant material after being deposited into the wrapper 26, for example.

While the buttons 110 are shown at the top of the motor section 94, in general the buttons 110 may be disposed along any suitable external surface of the apparatus 10 for example.

Referring to FIG. 4, the apparatus 10 in the first embodiment includes at least one auxiliary module 50 forming a storage compartment 112 for storing accessories (not shown), miscellaneous items, and/or plant material. Each storage compartment 112 shown in FIG. 4 includes three divided sections and three corresponding section covers 114. In the first embodiment, the section covers 114 are sealing covers 114 to advantageously provide sealable enclosures for different types of plant material, including different strains of plant material. Such sealable enclosures in some embodiments are configurable as odor-proof enclosures or, alternatively, as odor-reducing enclosures. In some embodiments, the section covers 114 include retaining clip(s), retaining strap(s), fastener(s), or other holding mechanism(s) for supporting a humidity pack and/or a desiccant pack within the divided section under the section cover 114. Typically, each holding mechanism for the humidity and/or desiccant pack(s) is disposed at the underneath side of the section cover 114, but in general may be disposed anywhere within the storage compartment 112.

While the storage compartments 112 shown in FIG. 4 each include three divided sections having three section covers 114, in general any number and combination of numbers of divided sections and section covers 114 may be employed or omitted. In some embodiments, section dividers are adjustable or otherwise moveable.
The storage compartments 112 shown in FIG. 4 are hingedly attached to the main part of the grinder section 52 by hinge(s) 116, so that each storage compartment 112 is rotatable between a closed position (FIGS. 1 to 3) and an open position (FIG. 4) perpendicularly oriented to its closed position. Placing the storage compartment 112 in its open position provides access to its divided sections 114. In variations, any limited number of the storage compartments 112 may be rotatably and/or slidably coupled to the main part of either or both of the grinder section 52 and the holder section 18. Additionally or alternatively, the storage compartment(s) 112 may be removably attachable to the main part of either or both of the grinder section 52 and the holder section 18.

Auxiliary modules 50 of a variety of different types may employed. For example, one or more modules 50 may be one or more audio speakers 50, which may be Bluetooth™ speakers 50 or similar controllable via any suitable digital computation device. For example, the audio speaker(s) 50 may be controllable via any paired smart phone, tablet computer, or the like. Additionally or alternatively, the audio speaker(s) 50 may be controllable by the processor or other processing circuit of the docking station 12, the controller or other circuitry of the electrical 98 of the motor section 94, other processing circuit of the apparatus 10, or any combination thereof for example. Each speaker 50 may include a cable and/or a connector for receiving a cable connecting the speaker 50 to another speaker for stereo sound. The other speaker may, but need not, be formed as an auxiliary module 50. In some embodiments, one or more audio speaker(s) are incorporated into the storage compartment(s) 112.

One or more auxiliary modules 50 may be a personal vaporizer for vaporizing active ingredients (not shown). In some embodiments, the apparatus 10 includes an adapter (not shown) to permit a commercially available vaporizer to be removably attached to the apparatus 10 in the manner of an auxiliary module 50. In some embodiments, the apparatus 10 includes a vaporizer specifically dimensioned as an auxiliary module 50 of the apparatus 10.

In some embodiments, one or more modules 50 may constitute or include a dry herb vaporizer for vaporizing dried plant material, including vaporizing the ground plant material produced by the apparatus 10, to produce a human-inhalable vapor (not shown) for adult use. In such uses, the grinder 54 is advantageously useable to grind plant material and deposit the ground plant material into the wrapper support 22 with or without a wrapper 26. Thereafter, the ground plant material may then be transferred from the wrapper support 22, with or without the wrapper 26, to the dry herb vaporizer of module 50.

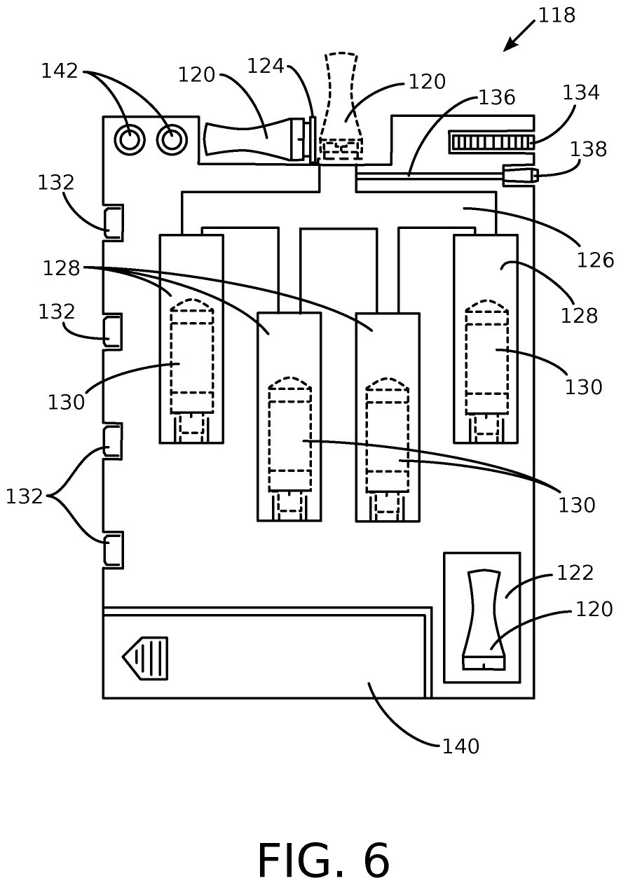

Referring to FIGS. 4 and 6, in some embodiments one or more auxiliary modules 50 may constitute an oil vaporizer 118 for vaporizing oils to produce a human-inhalable vapor (not shown) for adult use. By way of illustration, one oil vaporizer 118 is shown in each of FIGS. 4 and 6. In the first embodiment, the oil vaporizer 118 is removably attachable to the main part of the holder section 18. In some embodiments the oil vaporizer 118 is removably attachable to the main part of the grinder section 52, and in some embodiments the oil vaporizer 118 is removably attachable to the main part of either one of the holder section 18 and the grinder section 52.

The oil vaporizer 118 in the first embodiment includes a mouthpiece 120 for inhaling the vapor produced by the oil vaporizer 118. The mouthpiece 120 in the first embodiment is preferably replaceable. As shown in FIG. 6, the oil vaporizer 118 in some embodiments is dimensioned to include a storage space 122 for storing a spare mouthpiece 120. In general, the oil vaporizer 118 can be dimensioned for storing any suitable number of spare mouthpieces 120. In the first embodiment, the mouthpiece 120 is removably attachable to a mouthpiece base 124 that is operable to rotate between a storage position, in which the mouthpiece 120 (shown by solid lines in FIG. 6) is oriented so as to not protrude beyond the oil vaporizer 118 top, and an active-use position, in which the mouthpiece 120 (shown by dotted lines in FIG. 6) is oriented to protrude beyond the oil vaporizer 118 top for accessible use. In variations, the oil vaporizer 118 may be operable to slide the mouthpiece 120 between its storage and active-use positions, flip the mouthpiece 120 by 180 degrees or nearly 180 degrees between its storage and active-use positions, provide for other movements, or any combination thereof for example. In some embodiments, the oil vaporizer 118 does not operate to provide movement between storage and active-use positions, but rather relies solely on the removable aspect of the mouthpiece 120 to ensure the mouthpiece 120 does not protrude obstructively when the oil vaporizer 118 is being attached to the main part of the holder section 18 and/or grinder section 52.

Referring to FIG. 6 and in accordance with the first embodiment, the inhalable vapor (not shown) is provided to the mouthpiece base 124 via a manifold 126 connected to four oil cartridge compartments 128. Each oil cartridge compartment 128 is operable to receive one replaceable oil cartridge 130, for which a total of four are shown by dotted lines in FIG. 6. The oil vaporizer 118 is operable in the first embodiment to combine within the manifold 126 the vapors (not shown) of up to four oil cartridges 130 to present a combined vapor at the mouthpiece 120 when it is in its active-use position. In the first embodiment, each vapor travels approximately the same distance through the manifold 126 from its oil cartridge 130 to the mouthpiece 120, thereby advantageously providing a uniform combination of vapors.

In some embodiments, each oil cartridge compartment 128 includes a foam or foam-like material for supporting the oil cartridge 130 within its compartment 128.

In the first embodiment, the oil vaporizer 118 includes a plurality of actuators such as the four control buttons 132 for independently controlling the operation of the four oil cartridges 130, respectively. When a user presses one of the buttons 132, the corresponding oil cartridge 130 is activated to produce vapor (not shown). By inserting oil cartridges 130 having different oils, such as oils associated with different plant sources and/or different flavours for example, and then selectively pressing the control buttons 132, a user can advantageously produce at the mouthpiece 120 a customizable combined vapor in a variety of changeable permutations.

While FIG. 6 shows four oil cartridge compartments 128, in general any suitable number of oil cartridge compartments 128 may be employed to receive any suitable number of oil cartridges 130. In some embodiments, the oil vaporizer 118 is dimensioned to include storage space (not shown) for spare oil cartridges 130. Additionally or alternatively, the apparatus 10 may include storage space specifically dimensioned for spare oil cartridge(s) 130 elsewhere.

The oil vaporizer 118 in the first embodiment is operable to adjustably control the electrical power administered to the oil cartridges 130, and hence adjustably control the average temperature of the vaporizing heat produced the oil cartridges 130. In the first embodiment, the oil vaporizer 118 includes a user-controllable temperature-adjustment dial 134 for adjusting the average temperature of the heat produced by the oil cartridges 130.

The oil vaporizer 118 in the first embodiment further includes a passageway 136 for controlling the intake of ambient air into the manifold 126. Introducing more ambient air into the manifold 126 alters the quality of the vapor produced at the mouthpiece 120. In the first embodiment, the oil vaporizer 118 includes a user-operable air-choke for adjusting the intake of ambient air. The air-choke may be in the form of a valve (not shown) controlled by the air-choke switch 138, for example. Typically, the air-choke is in addition to the ordinary intake air flows (not shown) of each oil cartridge 130.

A battery compartment 140 of the oil vaporizer 118 in the first embodiment is dimensioned to receive one or more batteries (not visible) to power the oil cartridges 130. The one or more batteries may be standard rechargeable batteries, for example. In some embodiments, the docking station 12 is operable to recharge the batteries of the oil vaporizer 118 when it is attached to a main part of the apparatus 10 so as to form an electrical connection with the docking station 12. In some embodiments, the one or more batteries of the oil vaporizer 118 must be removed for recharging in a manner known in the art.

The oil vaporizer 118 in the embodiment shown in FIG. 6 includes a pair of light sources, such as the light-emitting diodes (LEDs) 142, for providing indications of the operation of the oil vaporizer 118. By way of example, one LED 142 may be operable to indicate when one or more oil cartridges 130 is being activated. As a further example, one LED 142 may be operable to indicate when the battery of the oil vaporizer 118 is being charged and/or when it is charged. In general, any number of LEDs 140 for any suitable purpose(s) may be employed.

Referring back to FIG. 4, in some embodiments, one or more auxiliary modules 50 include or consist of a smoking pipe. Additionally or alternatively, the apparatus 10 may be dimensioned to removably hold a smoking pipe, which may be a commercially available smoking pipe for example.

Referring to FIG. 5, the motor section 94 in some embodiments is rotatably coupled to the grinder section 52 via one or more hinges 144 so as to provide access to the upper cutting end 72 of the chamber 58 for insertion of plant material to be processed. As best seen in FIG. 5, the motor 96 includes a motor output shaft 146 dimensioned for coupling to the shaft 68. In the first embodiment, the shaft 68 is dimensioned for coupling to the motor output shaft 146, and is stabilized by the stabilizing crossbar 148. The shaft 68 in the first embodiment is also operable to be manually rotated in either direction by a wrench (not shown) or other tool, thereby advantageously permitting non-motorized cutting and grinding of plant material.

In some embodiments, the processor of the apparatus 10 is operable to count the number of uses of the apparatus 10. In some embodiments, the processor of the apparatus 10 is operable to count the number of rotations of the shaft 68, calculate an estimated number of cigarettes produced by use of the apparatus 10, and display or otherwise indicate the calculated estimate.

Referring back to FIG. 1, in some embodiments one or more of the attachment mechanism(s) for attaching the motor section 94, grinder section 52, the holder section 18, and the docking station 12 to each other and/or one or more of the attachment mechanism(s) for attaching the auxiliary modules 50 are child-safety mechanisms to facilitate restricting use of the apparatus 10 to adult use only.

Some embodiments of the apparatus 10 are sold with a weatherproof case (not shown).

### Method of Operation

Referring to FIG. 3, an adult user gains access to the interior topside of the holder 20, such as by moving the holder 20 into its non-aligned position and/or by removing the grinder section 52 from the holder section 18. Upon accessing the holder 20, the user inserts an empty wrapper 26, such as by employing the tweezers 40 of the tamping tool 38, into a correspondingly dimensioned wrapper support 22 that had previously been inserted into the holder 20. Alternatively, the empty wrapper 26 can be inserted into the correspondingly dimensioned wrapper support 26 and then both inserted together into the holder 20. Referring to FIGS. 1 and 2, the user then returns the holder 20 to its aligned position in alignment with the grinder section 52 and ensures the holder section 18 and the grinder section 52 are attached to each other.

Referring to FIGS. 1 and 5, the user gains access to the upper cutting end 72 of the chamber 58, such as by removing or hingedly rotating the motor section 94 away from the grinder section 52. Plant material of a desired quantity is then inserted into the upper cutting end 72 and the motor section 94 is returned to its closed position (FIG. 1) attached to the grinder section 52.

With plant material inserted into the grinder 54, the user activates the grinder 54, such as by pressing the appropriate button 110 or remotely controlling the apparatus 10. Activating the grinder 54 causes, under the control of electronic circuitry of the electrical board 98 (FIG. 2), electrical power to be supplied to the motor 96, which in turn causes the motor output shaft 146 to rotate. The shaft 68 rotates due to the coupling of the motor output shaft 146 and the shaft 68 when the motor section 94 and the grinder section 52 are attached to each other. In some embodiments, the shaft 68 is caused by electronic circuitry to rotate in one direction followed by rotation in the opposing direction. In some embodiments, such bi-directional rotation is repeated a specified number of times. Additionally or alternatively, in some embodiments such bi-directional rotation is repeated as long as the appropriate button 110 remains pressed.

As grinding occurs, the ground plant material that is deposited into the wrapper 26 is visible to the user through the window 28. When a desired amount of grinding and depositing has occurred, the user may cease the grinding operation or allow the grinding operation to cease. If so desired, the user may access the interior sides of the holder 20 by moving it into its non-aligned position. The tamping tool 38 at its tamping surface 44 may then be used to tamp the ground plant material previously deposited into the wrapper 26.

The holder 20 may then be returned to its aligned position in alignment with the grinder 54 for further grinding. Additional plant material may also be inserted into the upper cutting end 72, if desired. The process of inserting plant material, grinding the plant material to produce ground plant material, and tamping the ground plant material in the wrapper 26 may be repeated as desired.

With a desired amount of ground plant material deposited and possibly also tamped within the wrapper 26, the holder 20 can be moved to its non-aligned position and/or the grinder section52 separated from the holder section 18, to provide user access to the filled wrapper 26. The filled wrapper 26 is removed from the wrapper support 22, such as by using the tweezers 40, and its open end closed, such as by twisting the end of the filled wrapper 26. The filled wrapper 26 is then useable by an adult as a personal smokable product.

Additionally or alternatively, one or more auxiliary modules 50 may be employed according to their respective functions, including in the case of either or both of the dry herb vaporizer and the oil vaporizer 118 as personal inhalable devices for adult use.

When the battery 100 becomes discharged, the motor section 94, the grinder section 52, the holder section 18, and the docking station 12 may be attached to each other as shown in FIG. 1, and electrical power provided to the docking station 12, such as via the USB connector 14, until the battery 100 becomes fully charged.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

1. An apparatus for preparing a personal smokable product, the apparatus comprising:
(a) a grinder section comprising a grinder for grinding plant material; and
(b) a holder section attachable to said grinder section and comprising a holder operable to move between an aligned position in alignment with said grinder and a non-aligned position out of alignment with said grinder, said holder being operable to removably receive a wrapper support when said grinder section and said holder section are attached to each other if said holder is in said non-aligned position, said wrapper support being dimensioned to support a wrapper, said grinder being operable to grind the plant material such that ground plant material moves into the wrapper supported by said wrapper support received by said holder when said holder is in said aligned position.

2. The apparatus of claim 1 wherein said grinder section and said holder section are removably attachable to each other.

3. The apparatus of claim 1 wherein said holder is operable to removably receive any one of a plurality of said wrapper supports differently dimensioned from each other, each said differently dimensioned wrapper support being operable to support a correspondingly dimensioned one of a plurality of the wrappers.

4. The apparatus of claim 1 wherein said holder is rotatably coupled to said holder section.

5. The apparatus of claim 1 wherein said holder comprises a window for viewing the ground plant material received into the wrapper, said wrapper support not being opaque.

6. The apparatus of claim 5 wherein said holder comprises a light source for illuminating the ground plant material received by the wrapper supported by said wrapper support received by said holder.

7. The apparatus of claim 1 wherein said holder section comprises a magnet for holding said holder in said aligned position.

8. The apparatus of claim 1 wherein said holder is dimensioned to removably hold a tamping tool.

9. The apparatus of claim 8 wherein said tamping tool defines a first end and a second end opposite said first end, said tamping tool defining at said first end a tamping surface, said tamping tool comprising tweezers at said second end.

10. The apparatus of claim 1 wherein said wrapper support is frusto-conical and open-topped.

11. An apparatus for preparing a personal smokable product, the apparatus comprising:
(a) a grinder section comprising a grinder for grinding plant material to produce ground plant material, said grinder defining a wall and a chamber interior of said wall, said chamber defining a central axis therethrough, said grinder comprising a cutter member for cutting plant material, said cutter member comprising:
(i) a plurality of spaced-apart wall blades projecting from said wall toward a first plurality of positions along the central axis;
(ii) a motor-driven shaft rotatable about the central axis, and
(iii) a plurality of spaced-apart shaft blades projecting radially from said shaft at a second plurality of positions along the central axis; and
(b) a holder section attachable to said grinder section and comprising a holder operable to removably receive a wrapper support dimensioned to support a wrapper operable to receive the ground plant material from said grinder.

12. The apparatus of claim 11 wherein said chamber defines an upper cutting end thereof, said plurality of shaft blades comprising at said upper cutting end a plurality of parallel shaft blades parallel to each other.

13. The apparatus of claim 11 wherein said chamber defines a lower cutting end thereof, said plurality of shaft blades comprising at said lower cutting end a plurality of non-parallel shaft blades extending radially from said shaft at a plurality of different radial angles.

14. The apparatus of claim 11 wherein said grinder further comprises a grinder member disposed within said chamber and disposed to receive cut plant material from said cutter member, said grinder member being operable to grind the cut plant material to produce the ground plant material, said grinder member comprising a pair of conical burr members.

15. The apparatus of claim 14 wherein said grinder member is operable to adjust the coarseness of the ground plant material in response to a coarseness setting.

16. The apparatus of claim 15 wherein said grinder member is operable to adjust a gap size between said conical burr members of said pair in response to said coarseness setting, said grinder section comprising a user-operable dial for determining said coarseness setting.

17. The apparatus of claim 11 wherein said grinder section and said holder section are removably attachable to each other.

18. The apparatus of claim 11 wherein said cutter member and said grinder member are driven by said motor-driven shaft.

19. The apparatus of claim 11 wherein said motor-driven shaft is operable to sequentially rotate in opposing rotational directions.

20. The apparatus of claim 11 wherein said chamber defines a cutting chamber and a grinding chamber, said cutting chamber being frusto-conical and defining a narrow cutting chamber end, said grinding chamber being frusto-conical and defining a narrow grinding chamber end coincident with said narrow cutting chamber end.

21. An apparatus for preparing a personal smokable product, the apparatus comprising:
(a) a grinder section comprising a grinder for grinding plant material to produce ground plant material;
(b) a holder section attachable to said grinder section and comprising a holder operable to removably receive a wrapper support dimensioned to support a wrapper for receiving the ground plant material;
(c) a dry herb vaporizer removably attachable to at least one of said grinder section and said holder section; and
(d) an oil vaporizer removably attachable to at least one of said grinder section and said holder section.

22. The apparatus of claim 21 further comprising a motor section attachable to said grinder section, said motor section comprising a motor operable to drive said grinder.

23. The apparatus of claim 22 wherein said motor is operable to drive a shaft of said grinder section, said motor section being operable to receive a battery for supplying electrical power to said motor.

24. The apparatus of claim 23 further comprising a docking station operable to charge said battery, said docking station being dimensioned to removably receive said holder section.

25. The apparatus of claim 22 wherein said motor section is removably attachable to said grinder section.

26. The apparatus of claim 22 wherein said motor section is dimensioned to removably contain a hand-portable lighter.

27. The apparatus of claim 21 further comprising at least one audio speaker removably attachable to at least one of said grinder section and said holder section.

28. The apparatus of claim 21 further comprising at least one storage compartment removably attachable to at least one of said grinder section and said holder section.

29. The apparatus of claim 21 wherein said holder section is dimensioned to provide storage space of sufficient size to contain said wrapper support.

30. The apparatus of claim 21 wherein said holder section is dimensioned to removably hold a tamping tool.

31. The apparatus of claim 30 wherein said tamping tool defines a first end and a second end opposite said first end, said tamping tool defining at said first end a tamping surface, said tamping tool comprising tweezers at said second end.

32. The apparatus of claim 21 wherein said oil vaporizer comprises a base member and a mouthpiece member attachable to said base member, said mouthpiece member being rotatable when attached to said base member between a useable position projecting from said base member and a storage position permitting said oil vaporizer to removably attach to said at least one of said grinder section and said holder section.

33. The apparatus of claim 32 wherein said base member comprises:
(i) a plurality of adapters for removably receiving a plurality of vapor cartridges operable to produce a plurality of vapors, respectively;
(ii) a plurality of user-operated actuators for actuating said plurality of vapor cartridges, respectively; and
(iii) a manifold for combining the plurality of vapors.

34. The apparatus of claim 33 wherein said base member further comprises a choke for regulating intake air flow to said manifold.

35. The apparatus of claim 32 wherein said base member is dimensioned to removably receive a battery for powering said plurality of vapor cartridges.
